(19) United States
(12) Patent Application Publication
(10) Pub. No.: US 2026/0365116 A1
(43) Pub. Date: Nov. 19, 2026

(54) HITCH MOUNTED CARRIER AND METHOD OF USE

(71) Applicant: Inventurous LLC, New Washington, OH (US)

(72) Inventors: David E. Kurtz, New Washington, OH (US); Katherine P. Kurtz, New Washington, OH (US)

(21) Appl. No.: 19/680,864

(22) Filed: May 18, 2026

Related U.S. Application Data
(60) Provisional application No. 63/806,849, filed on May 16, 2025.

(51) Int. Cl. B60R 9/06; B60D 1/52

(52) U.S. Cl. CPC B60R 9/065; B60D 1/52

(57) ABSTRACT

A vehicle mounting system and method is disclosed. The vehicle mounting system for a load-bearing container includes an elongated support member forming a hollow channel, a front stabilizing bracket coupled to the elongated support member at a first inlet of the elongated support member, a container having a continuous sidewall extending into a planar portion having first and second sides, the planar portion having a recess which is coupled to the front stabilizing bracket at the first side, the container having first and second flanges at the second side, a rear stabilizing bracket coupled to the elongated support member, and first and second side support members forming a nested arrangement with the first and second flanges of the container, the first and second side support members being coupled to the rear stabilizing bracket and having an inlet extending through their sidewalls which holds an axle rod.

### CROSS REFERENCES TO RELATED APPLICATIONS

The following application claims priority under 35 U.S.C. § 119 (e) to U.S. Provisional Patent Application Serial No. 63/806,849 filed May 16, 2025 entitled HITCH MOUNTED CARRIER AND METHOD OF USE. The above-identified application is incorporated herein by reference in its entirety for all purposes.

### TECHNICAL FIELD

The present disclosure generally relates to a hitch mounted carrier and method of use, and more particularly to a vehicle mounting and stabilization system for hauling a load-bearing container and process for using the same.

### BACKGROUND

In rural areas, moving waste materials in a container involves extensive effort and energy. If garbage and yard waste materials are collected by a waste removal service at the curbside of a residence, homeowners may need to move waste receptacles several yards over uneven terrain to have their trash collected.

### SUMMARY

In one aspect, the present disclosure includes a vehicle-mounting container system adapted and configured to be removably couplable to a vehicle receiver. The system includes an elongated support member having first and second ends forming a hollow channel, a front stabilizing bracket defining a first planar surface and a second planar surface formed at an angle to the first planar surface, the first planar surface coupled to the elongated support member between the first and second ends of the elongated support member, a container having a continuous sidewall extending from a base portion, the continuous sidewall and the base portion together forming a hollow cavity, the base portion including first and second flanges, the base portion being removably attached to the front stabilizing bracket, a rear stabilizing bracket having first and second ends, the rear stabilizing bracket coupled to the elongated support member at the elongated support member first end, and first and second side support members forming a nested arrangement with the first and second flanges of the container, the first and second side support members being coupled to the first end and the second end of the rear stabilizing bracket, respectively, the first and second side support members supporting first and second ends of an axle rod extending therethrough.

In another aspect, the present disclosure includes a vehicle-mounting apparatus adapted and configured to removably couple a load-bearing container to a vehicle receiver. The vehicle-mounting apparatus includes an elongated support member having first and second ends forming a hollow channel, a front stabilizing bracket defining a first planar surface and a second planar surface formed at an angle to the first planar surface, the first planar surface coupled to the elongated support member between the first and second ends of the elongated support member; a rear stabilizing bracket having first and second ends, the rear stabilizing bracket coupled to the elongated support member at the elongated support member first end, and first and second side support members, the first and second side support members being coupled to the first end and the second end of the rear stabilizing bracket, respectively.

In yet another aspect, the present disclosure includes as method of using a vehicle mounting system for a load-bearing container adapted and configured to be removably couplable to a vehicle receiver. The method includes the steps of providing a container having a base portion and a continuous sidewall, the base portion and continuous sidewall together forming a hollow cavity, the base portion including a recessed portion opposite first and second flanges, coupling a front stabilizer bracket to the recessed portion of said container, coupling first and second side supports to the first and second flanges of said container, the first and second side supports forming a nesting arrangement with the first and second flanges, coupling a rear stabilizer bracket to the first and second side supports, and coupling an elongated support member having first and second ends forming a hollow channel therein to the front and rear stabilizer brackets, the first end of the elongated support member cantilevered from the base portion of the container.

### BRIEF DESCRIPTION OF THE DRAWINGS

The foregoing and other features and advantages of the present disclosure will become apparent to one skilled in the art to which the present invention relates upon consideration of the following description of the invention with reference to the accompanying drawings, wherein like reference numerals refer to like parts unless described otherwise throughout the drawings and in which:

FIG. 1 illustrates a front view of a vehicle mounting system in accordance with one example embodiment of the present disclosure;

FIG. 2A illustrates a side view of a front stabilizer in accordance with another example embodiment of the present disclosure;

FIG. 2B illustrates a rear view of a front stabilizer in accordance with another example embodiment of the present disclosure;

FIG. 3A illustrates a rear view of a side stabilizer in accordance with another example embodiment of the present disclosure;

FIG. 3B illustrates a side view of a side stabilizer in accordance with another example embodiment of the present disclosure;

FIG. 4A illustrates a side view of a rear stabilizer in accordance with another example embodiment of the present disclosure;

FIG. 4B illustrates a top view of a rear stabilizer in accordance with another example embodiment of the present disclosure;

FIG. 4C illustrates a front view of a rear stabilizer in accordance with another example embodiment of the present disclosure;

FIG. 5A illustrates a left side view of a vehicle mounting system in accordance with another example embodiment of the present disclosure;

FIG. 5B illustrates a right side view of a vehicle mounting system in accordance with another example embodiment of the present disclosure;

FIG. 6A illustrates a side view of an elongated bracket in accordance with another example embodiment of the present disclosure;

FIG. 6B illustrates a top view of an elongated bracket in accordance with another example embodiment of the present disclosure;

FIG. 6C illustrates a front view of an elongated bracket in accordance with another example embodiment of the present disclosure;

FIG. 6D illustrates a bottom view of an elongated bracket in accordance with another example embodiment of the present disclosure;

FIG. 7 illustrates a top view of a vehicle mounting system in accordance with another example embodiment of the present disclosure;

FIG. 8 illustrates a top perspective view of a vehicle mounting system assembled with a container in accordance with another example embodiment of the present disclosure;

FIG. 9 illustrates a perspective view of a vehicle mounting system assembled with a container in accordance with another example embodiment of the present disclosure;

FIG. 10 illustrates another perspective view of a vehicle mounting system assembled with a container in accordance with another example embodiment of the present disclosure;

FIG. 11 illustrates a side view of a vehicle mounting system assembled with a container in accordance with another example embodiment of the present disclosure;

FIG. 12 illustrates another side view of a vehicle mounting system assembled with a container in accordance with another example embodiment of the present disclosure;

FIG. 13 illustrates a perspective view of a vehicle mounting system assembled with a container in accordance with another example embodiment of the present disclosure;

FIG. 14 illustrates a perspective view of a vehicle mounting system assembled with a container in accordance with another example embodiment of the present disclosure;

FIG. 15 illustrates a bottom plan view of a front and rear stabilizer in accordance with another example embodiment of the present disclosure;

FIG. 16 illustrates a top plan view of a front and rear stabilizer in accordance with another example embodiment of the present disclosure;

FIG. 17 illustrates first and second inlets and fasteners in a container compatible with a vehicle mounting system in accordance with another example embodiment of the present disclosure;

FIG. 18A illustrates a front stabilizer in accordance with another example embodiment of the present disclosure;

FIG. 18B illustrates a front stabilizer in accordance with another example embodiment of the present disclosure;

FIG. 18C illustrates a front stabilizer in accordance with another example embodiment of the present disclosure;

FIG. 18D illustrates a front stabilizer in accordance with another example embodiment of the present disclosure;

FIG. 19 illustrates an elongated bracket and rear stabilizer next to a container to show the scale of the system in accordance with another example embodiment of the present disclosure;

FIG. 20 illustrates an elongated bracket and rear stabilizer next to a container to show the scale of the system in accordance with another example embodiment of the present disclosure;

FIG. 21 illustrates an elongated bracket and rear stabilizer next to a container to show the scale of the system in accordance with another example embodiment of the present disclosure;

FIG. 22 illustrates an elongated bracket and rear stabilizer next to a container to show the scale of the system in accordance with another example embodiment of the present disclosure;

FIG. 23A illustrates a pair of side stabilizers in accordance with another example embodiment of the present disclosure;

FIG. 23B illustrates a pair of side stabilizers in accordance with another example embodiment of the present disclosure;

FIG. 23C illustrates a pair of side stabilizers in accordance with another example embodiment of the present disclosure;

FIG. 23D illustrates a pair of side stabilizers in accordance with another example embodiment of the present disclosure;

FIG. 24 illustrates a front view of a pair of side stabilizers assembled with a container in accordance with another example embodiment of the present disclosure;

FIG. 25 illustrates a side perspective view of a pair of side stabilizers assembled with a container in accordance with another example embodiment of the present disclosure;

FIG. 26 illustrates a pair of side stabilizers and a front stabilizer assembled with a container in accordance with another example embodiment of the present disclosure;

FIG. 27 a pair of side stabilizers and a front stabilizer assembled with a container in accordance with another example embodiment of the present disclosure;

FIG. 28 a top view of a pair of side stabilizers and a front stabilizer assembled with a container in accordance with another example embodiment of the present disclosure;

FIG. 29 illustrates a rear view of a vehicle mounting system assembled with a container in accordance with another example embodiment of the present disclosure;

FIG. 30 illustrates the coupling of an elongated bracket and a front stabilizer in accordance with another example embodiment of the present disclosure;

FIG. 31 illustrates a top perspective view of a vehicle mounting system assembled with a container in accordance with one example embodiment of the present disclosure;

FIG. 32 illustrates a vehicle mounting assembly with an axle rod in accordance with another example embodiment of the present disclosure;

FIG. 33 illustrates a vehicle mounting assembly with an axle rod coupled with a container in accordance with another example embodiment of the present disclosure;

FIG. 34 illustrates a vehicle mounting assembly with an axle rod coupled with a container in accordance with another example embodiment of the present disclosure;

FIG. 35 illustrates a vehicle mounting assembly coupling a container to a vehicle in a locked position in accordance with one example embodiment of the present disclosure;

FIG. 36 illustrates a vehicle mounting assembly coupling a container to a vehicle in a locked position in accordance with another example embodiment of the present disclosure;

FIG. 37 illustrates a vehicle mounting assembly coupling a container to a vehicle in an extended position in accordance with another example embodiment of the present disclosure;

FIG. 38 illustrates another view of a vehicle mounting assembly coupling a container to a vehicle in a locked position in accordance with another example embodiment of the present disclosure;

FIG. 39 illustrates another view of a vehicle mounting assembly coupling a container to a vehicle in a locked position in accordance with another example embodiment of the present disclosure;

FIG. 40 illustrates a full container mounted to a vehicle by a vehicle mounting assembly in accordance with another example embodiment of the present disclosure;

FIG. 41 illustrates a container mounted to a vehicle mounting assembly and removed from the vehicle in accordance with another example embodiment of the present disclosure;

FIG. 42 illustrates a rear view of a container mounted to a vehicle mounting assembly and removed from the vehicle in accordance with another example embodiment of the present disclosure.

FIG. 43 illustrates a container for a vehicle mounting assembly in accordance with one example embodiment of the present disclosure;

FIG. 44 illustrates a container for a vehicle mounting assembly in accordance with another example embodiment of the present disclosure;

FIG. 45 illustrates a vehicle mounting assembly coupled to a container in accordance with another example embodiment of the present disclosure;

FIG. 46 illustrates a vehicle mounting assembly coupled to a container in accordance with another example embodiment of the present disclosure;

FIG. 47 illustrates a vehicle mounting assembly coupled to a container in accordance with another example embodiment of the present disclosure; and

FIG. 48 illustrates a method of use for a vehicle mounting assembly in accordance with another example embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements throughout unless otherwise noted. The present disclosure relates to a hitch mounted carrier and method of use, method of manufacture, and more particularly to a vehicle mounting and stabilization system for hauling a weighted container.

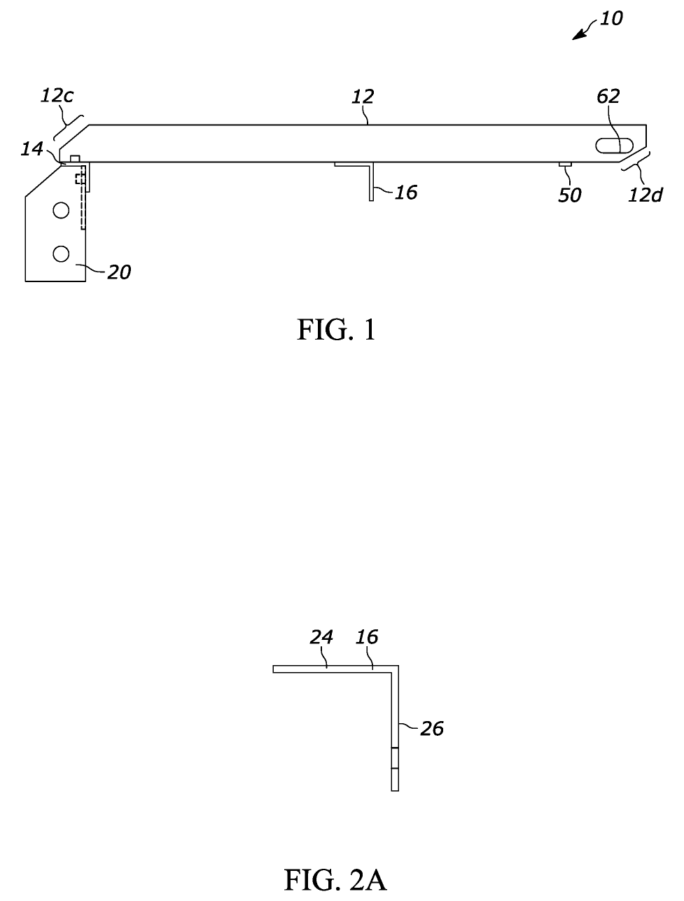

FIG. 1 illustrates a front view of a vehicle mounting system 10 in accordance with one example embodiment of the present disclosure. The vehicle mounting system 10 can be transported by various sizes of trucks, all-terrain vehicles, cars, tractors, mowers, trailers, or any transportation equipment having a hitch. The system 10 may also be used in connection with RVs and motorized mobile homes. All of the aforementioned trucks, trailers, recreational vehicles, and the like will be referred hereafter be encompassed as “vehicles” unless stated otherwise.

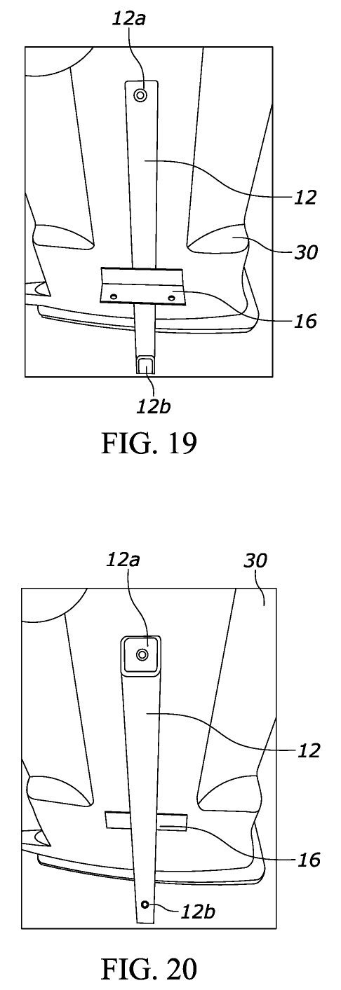

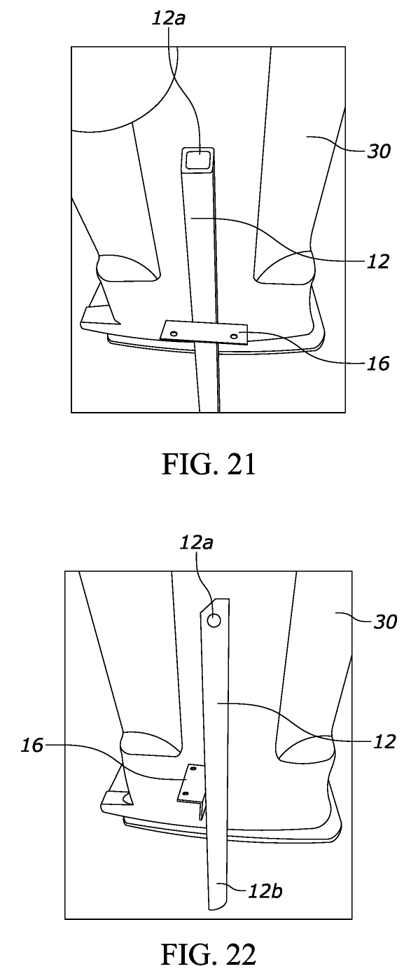

In one example embodiment, as illustrated in FIG. 1, the vehicle mounting system 10 includes an elongated support member 12, rear stabilizer 14, front stabilizer 16, and pair of side stabilizers 18, 20. In one example embodiment of the present disclosure, the elongated support member 12 is crafted in tubing with dimensions of 30.0" x 2.0" x 2.0" with wall thickness of 0.125". The elongated support member 12, as shown in FIGS. 19-22, has first 12a and second 12b ends and is formed to create an elongated channel 13 which is hollow to reduce weight. In one example embodiment of the present disclosure, the elongated channel 13 is formed to be cuboid and in the shape of a square. One of ordinary skill in the art, after having the benefit of reviewing the contents of the present disclosure, would understand that an elongated support member 12 in a variety of elongated three-dimensional geometric shapes is contemplated and within the spirit and scope of the present disclosure. The elongated support member 12, rear stabilizer 14, front stabilizer 16, and first 18 and second 20 side supports are constructed from powder coated steel, galvanized steel, iron, or an equivalent rust-resistant metal. It should be appreciated that the system 10 could also be made of high strength plastic, ABS, aluminum, and the like without departing from the spirit and scope of this disclosure.

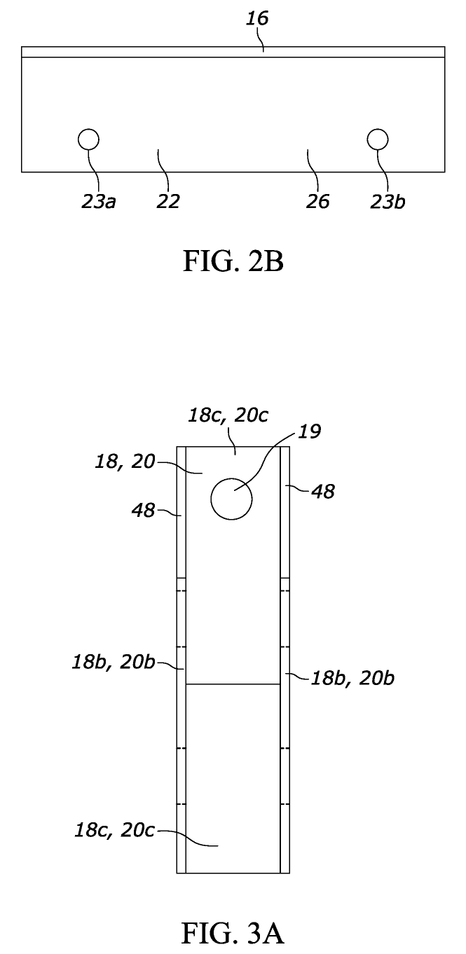

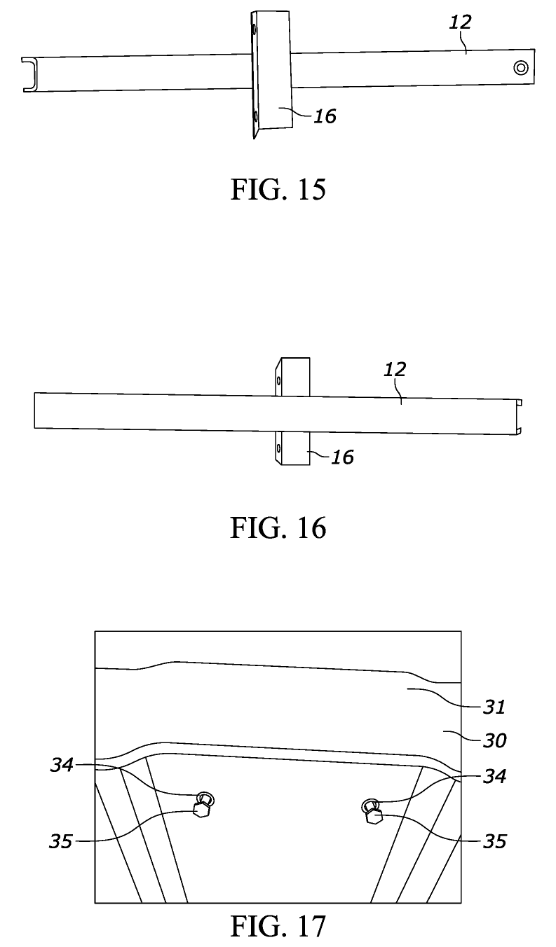

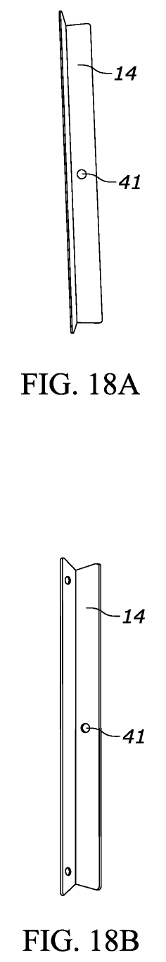

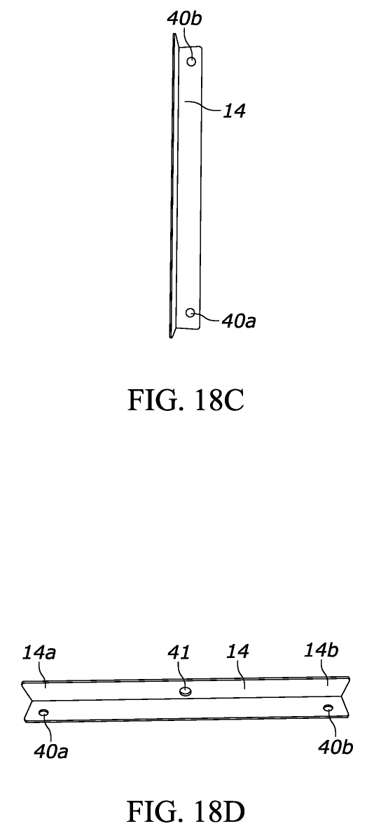

As shown in FIGS. 2A and 2B as well as FIGS. 15, 16, 18A-D, and 19, the front stabilizer 16 of the vehicle mounting system is an elongated L-bracket in one example embodiment of the present disclosure. Advantageously, the front stabilizer 16 couples or supports the elongated support member 12 to a container (see FIG. 9, for example) to stabilize the system 10. The elongated L-shape and 90 degree angle of the front stabilizer 16 is created at an abutment between vertically extending upper portion 24 and horizontally extending lower portion 26 sidewalls of the front stabilizer 16. In one example embodiment of the present disclosure, the front stabilizer 16 has dimensions of 7.0" x 2.0" x 2.0" crafted from angle iron with 0.125" wall thickness for each of the upper 24 and lower 26 portions. The upper portion 24 of the front stabilizer 16 includes a coupling inlet 25 for pairing the front stabilizer 16 with a rivet nut 27 or equivalent fastener with a locking mechanism to a first inlet 28 formed in the elongated support member 12. The lower portion 26 includes a pair of inlets 34 which provide passage for a pair of fasteners 35 to couple the lower portion 26 to a container 30.

The container 30 that is transported by the system 10 in one example embodiment is a trash container made from plastic sold by retailers such as big box stores and provided by municipalities. In another example embodiment, the container 30 is a trash can. In yet another example embodiment, the container 30 is any load-bearing storage arrangement having a volume for hauling objects.

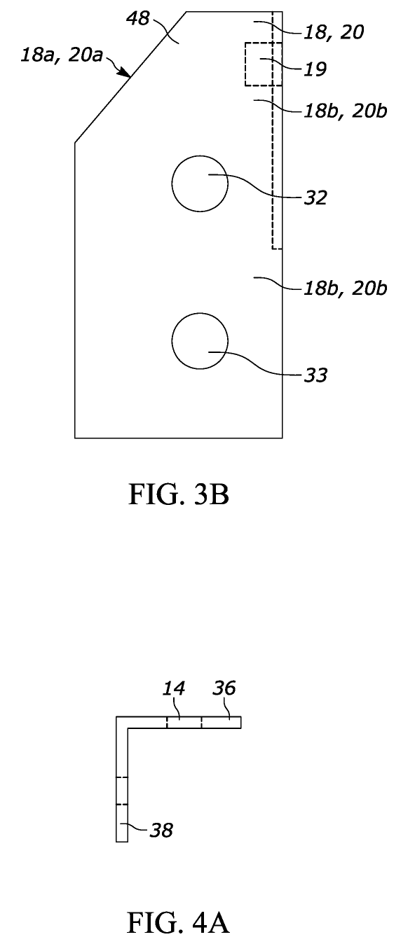

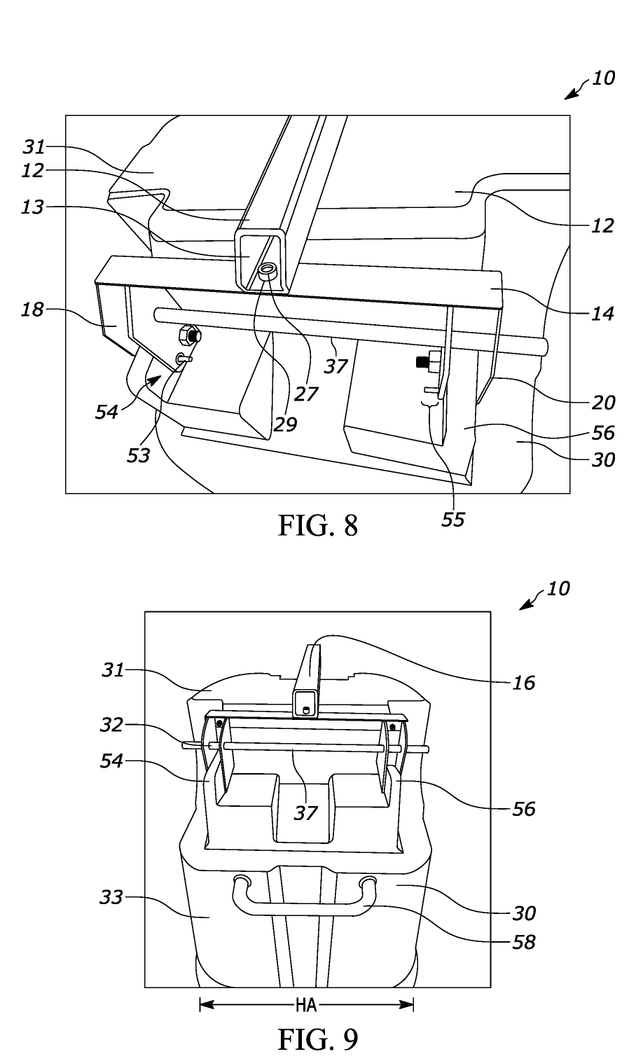

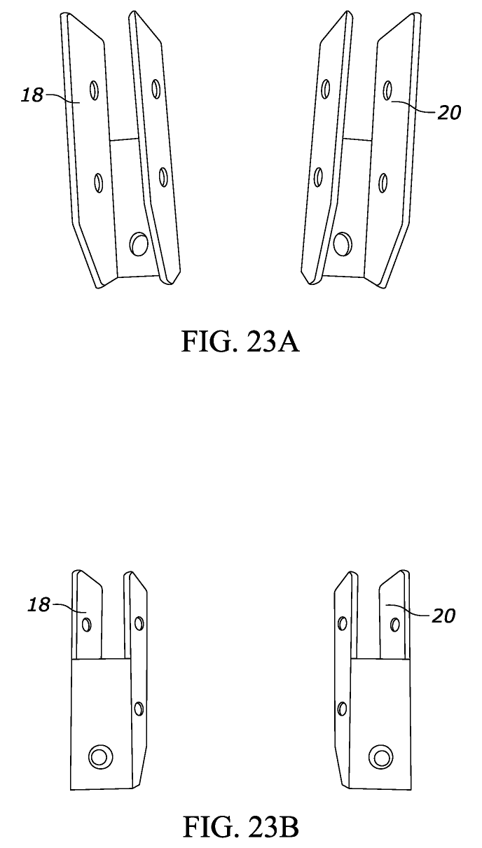

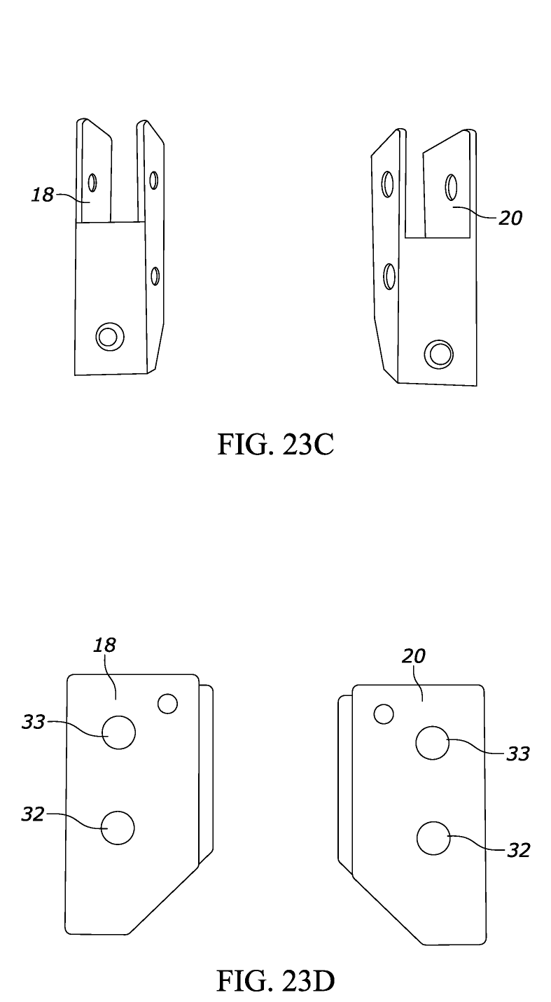

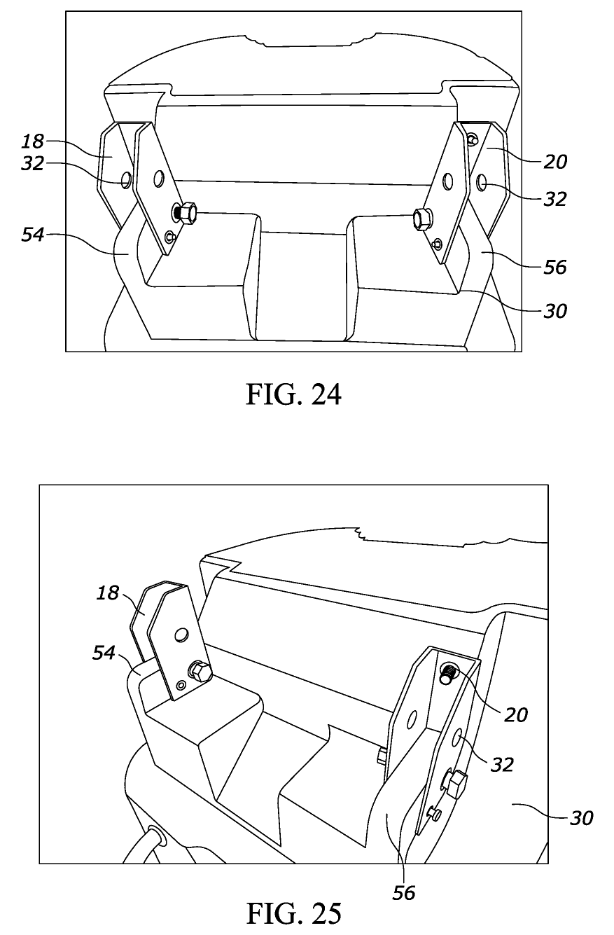

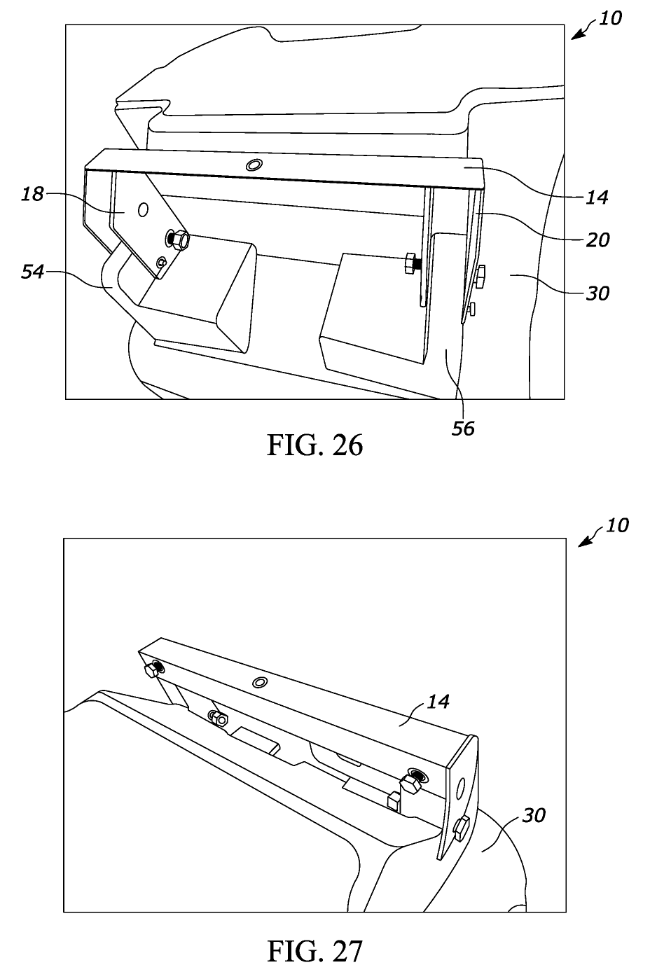

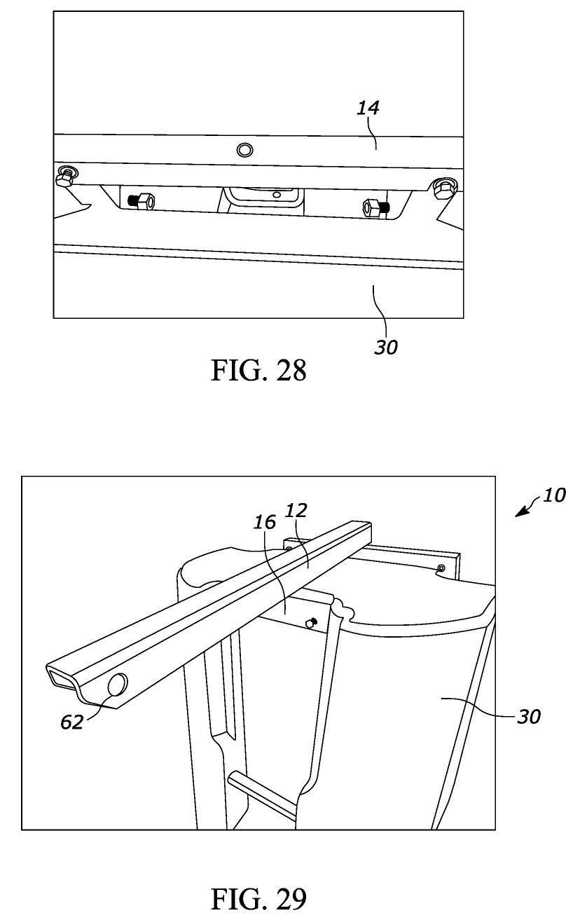

FIGS. 3A and 3B illustrate a rear and side view of side stabilizers 18, 20. In this example embodiment of the present disclosure, the side stabilizers 18, 20 are angled and or/chamfered edge brackets. Each of side stabilizers 18, 20 includes an axle inlet 32 and fastener inlet 33, as also shown in FIGS. 23A-23D. The first 18 and second 20 side supports are dimensioned and configured to support the container 30 at first 54 and second 56 flanges, as shown in FIGS. 24-28. The side stabilizers 18, 20 include sidewalls 18b, 20b, back walls 18c, 20c, and an open sidewall 18a, 20a, extending along a vertical axis VA. The fastener inlet 33 extends axially through the sidewalls 18b, 20b such that it provides support for, and couples to, first 56 and second 58 flanges of the container 30 when coupled by fasteners 35 such as a bolt and nut assembly. Additionally, the side supports 18, 20 axle inlet 32 supports an axle rod 37 along a horizontal axis HA, as shown in FIGS. 8 and 9, advantageously adding additional support for wheels 74 (see FIG. 39) and stabilizing the balance of the vehicle mounting system 10 when sustaining a load in container 30 during manual transport or during attachment to a vehicle as shown in the assembled arrangement in FIG. 37. The back walls 18c, 20c, include an opening 19 for a rivet nut or equivalent locking fastener such that a lower portion 38 of the rear stabilizer 14 is coupled to the back walls 18c, 20c. In another example embodiment shown in FIG. 8, the sidewalls 18b, 20b also include an additional inlet 53 which houses a pin assembly 55 to prevent rotation of the system 10.

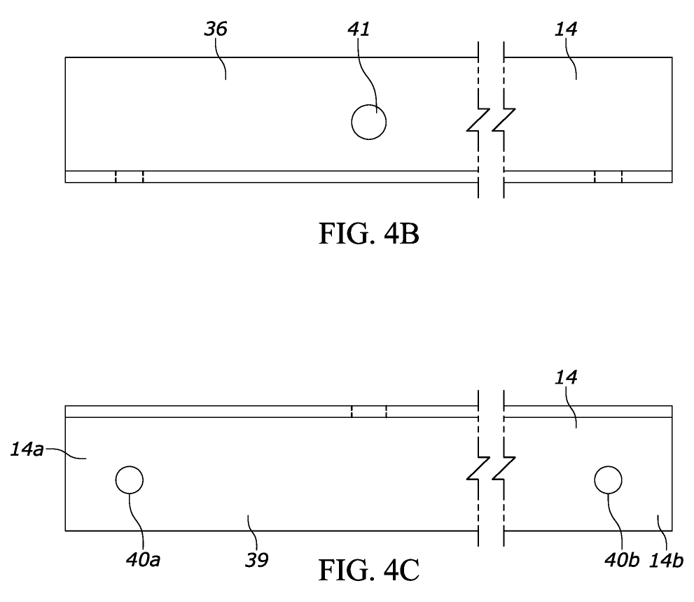

As shown in FIGS. 4A, 4B, and 4C, the rear stabilizer 14 is also an L-bracket in this example embodiment, including an upper portion 36 and lower portion 38, as with the front stabilizer 16. The rear stabilizer 14 includes an interface portion 39 in the lower portion 38 having first 40a and second 40b container coupling inlets sized to hold a pair of fasteners 35. The upper portion 36 of the rear stabilizer 14 includes a coupling inlet 41 for coupling the elongated support member 12 at second inlet 29 to the container 30 with a fastener such as rivet nut 27. In one example embodiment, the rear stabilizer 14 has dimensions of 16.375" x 1.500" x 1.500" crafted from angle iron with a wall thickness of 0.125".

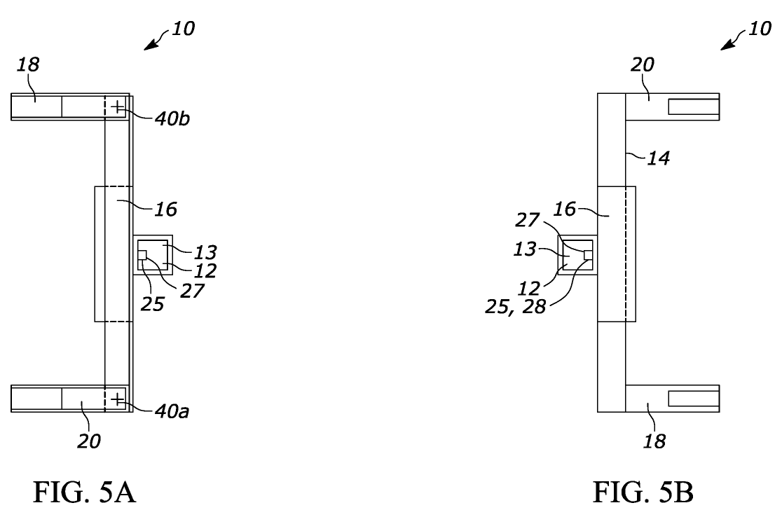

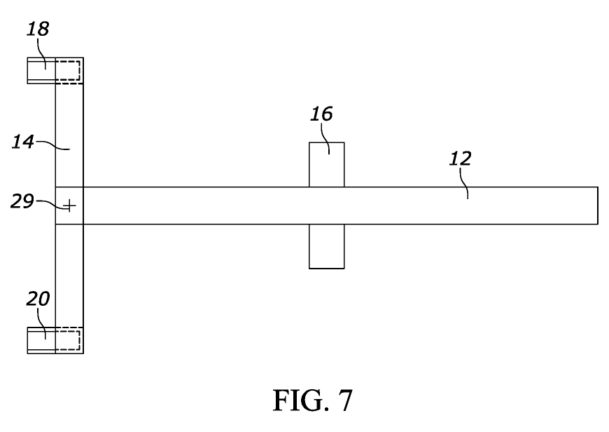

FIGS. 5A and 5B show a left and right side view, respectively, of the vehicle mounting system 10. First 14a and second 14b ends of the rear stabilizer 14 are coupled to side stabilizers 18, 20, respectively at first 40a and second 40b coupling inlets. These views of the vehicle mounting system 10 show the interface between the front stabilizer 16 and the elongated support member 12 coupled by rivet nut 27 at coupling inlet 25 and inlet 28, as well as the coupling between side supports 18, 20 and rear stabilizer 14 at inlets 19 with inlets 40a, 40b. FIG. 7 shows a top view of the vehicle mounting system 10 further illustrating the coupling of side supports 18, 20 with rear stabilizer 14 and elongated support member 12 with front stabilizer 16.

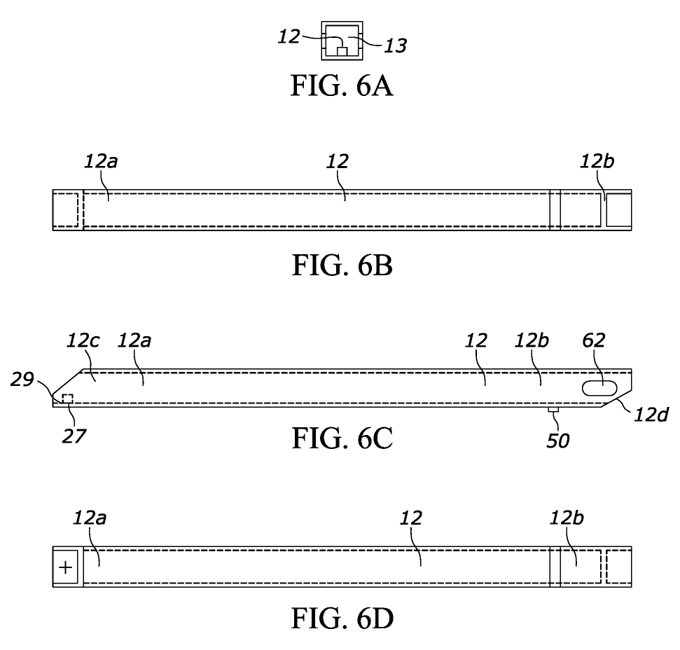

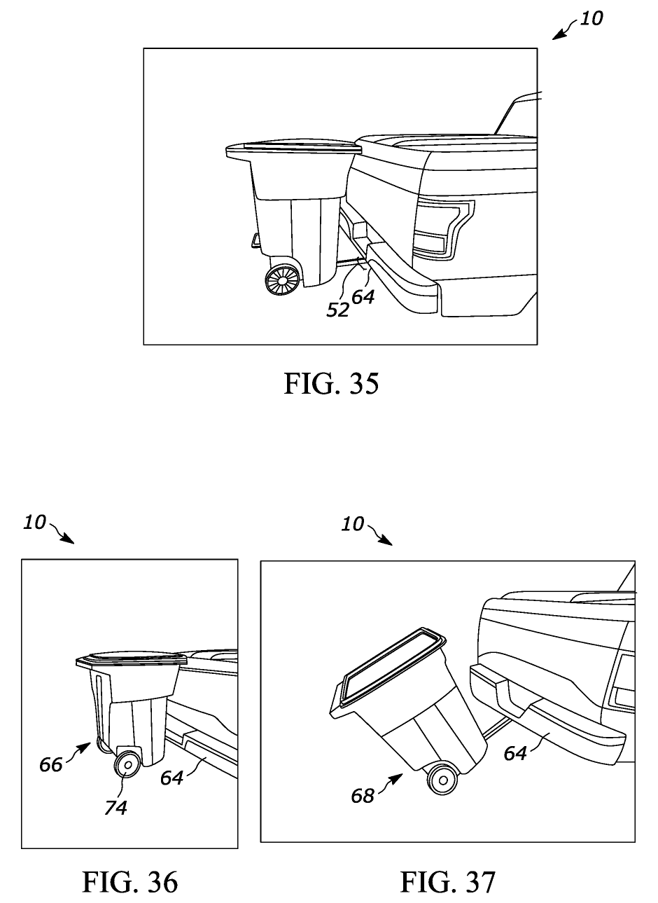

FIGS. 6A-6D illustrate various views of the elongated support member 12 in accordance with one example embodiment of the present disclosure. As shown in FIG. 6C, the elongated support member 12 forms a hollow elongated channel 13 and has first 12a and second 12b ends comprising angled and/or chamfered portions 12c, 12d. The elongated support member 12 further comprises a receiver stop 50 to prevent separation of the elongated support member 12 from a vehicle mounting assembly 52 (see FIG. 35). Additionally, the elongated support member 12 comprises a second inlet 29 which houses a rivet nut 27 that couples the elongated support member 12 to the rear stabilizer 14, as shown in FIG. 8.

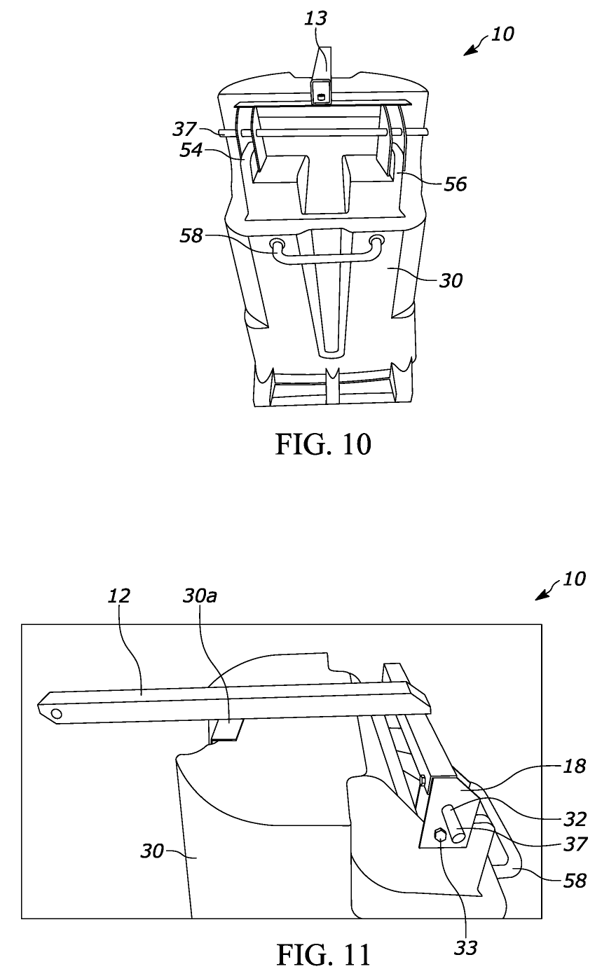

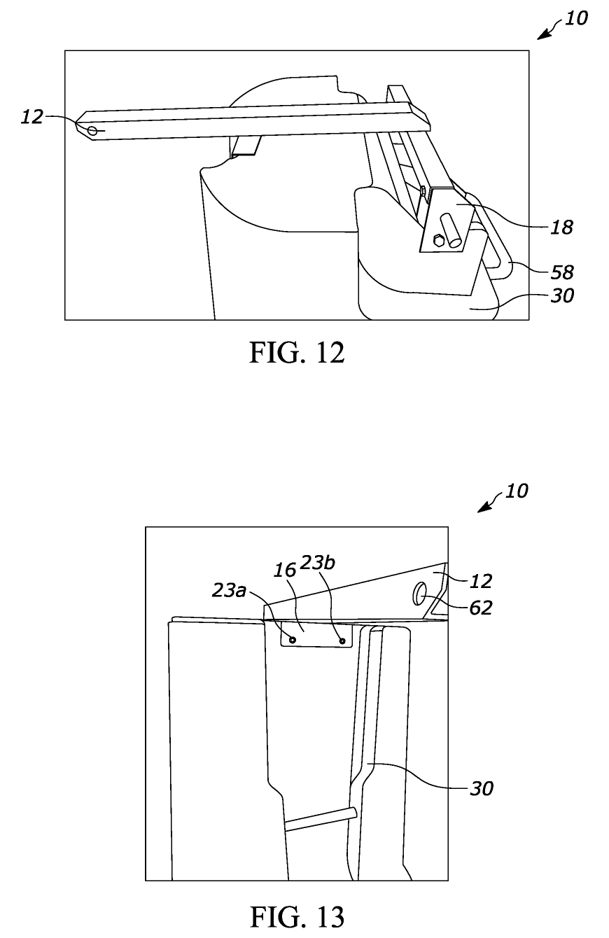

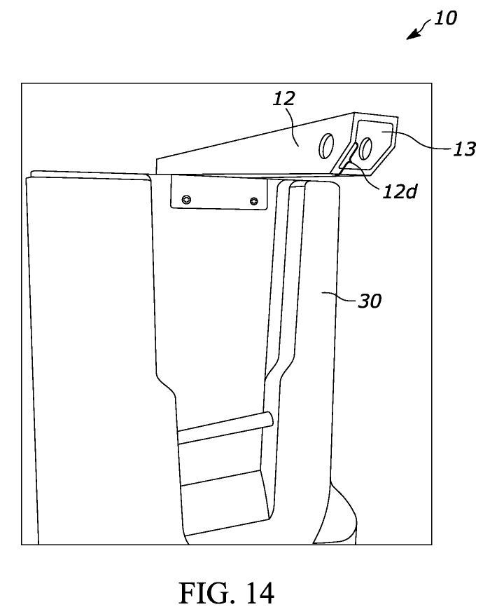

FIGS. 8-14 show the vehicle mounting system 10 in an assembled configuration in accordance with one example embodiment of the present disclosure. As shown in FIGS. 8 and 9, the container 30 is coupled to the vehicle mounting system 10 by the front stabilizer 16, rear stabilizer 14, and side supports 18, 20 to the vehicles receiver hitch. In one example embodiment of the present disclosure, the container 30 is a garbage receptacle composed of plastic, metal, and any combination thereof. One of ordinary skill in the art, after reviewing the specification and drawings of the present disclosure, would understand that a variety of sizes and capacities of container 30 are included in and compatible with the spirit and scope of the present disclosure. FIG. 17 shows a pair of inlets 34 formed in the container 30 for pairing the front stabilizer 16 at a recess 30a of the container 30.

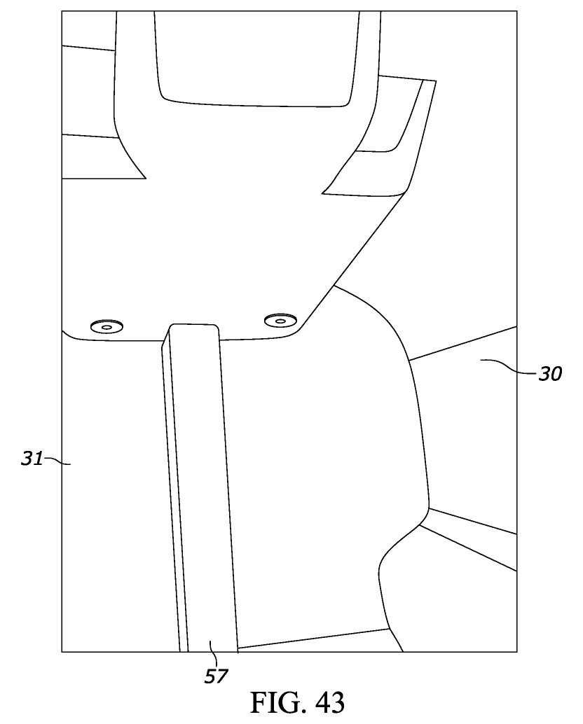

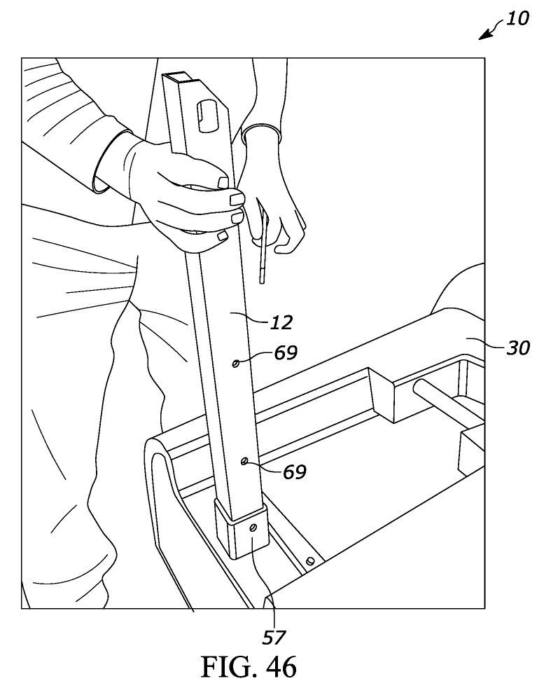

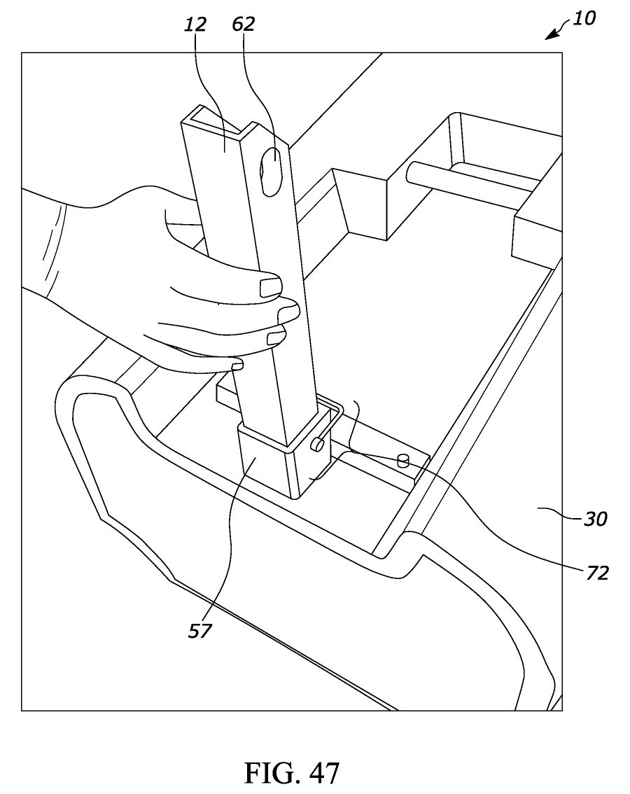

In one example embodiment of the present disclosure, the container 30 is formed by a continuous sidewall 33 extending into a substantially planar portion 31 and includes adjacent first 54 and second 56 flanges which form a nested arrangement with the open walls 18a, 20a of first and second side supports 18 and 20. The container 30 also includes a handle 58 in this example embodiment of the present disclosure. In another example embodiment of the present disclosure, as shown in FIGS. 43-47, the container 30 includes an embedded channel 57 that houses a second elongated support member 59 in which one part of a two-part elongated support member 12 nests to further secure the vehicle mounting system 10. One of ordinary skill in the art, after having the benefit of reviewing the contents of the present application and drawings, would understand that a variety of container configurations would be compatible with and included in the spirit and scope of the present disclosure.

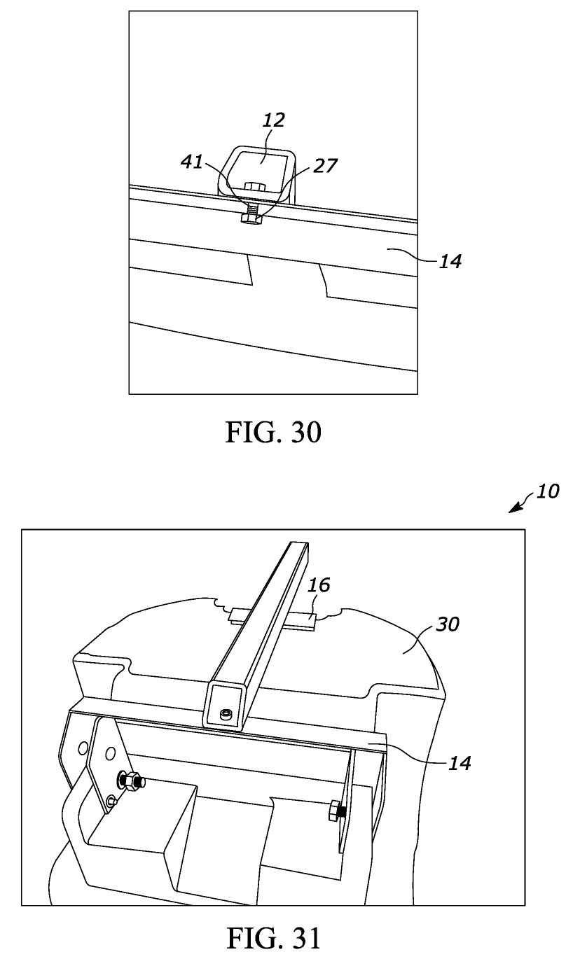

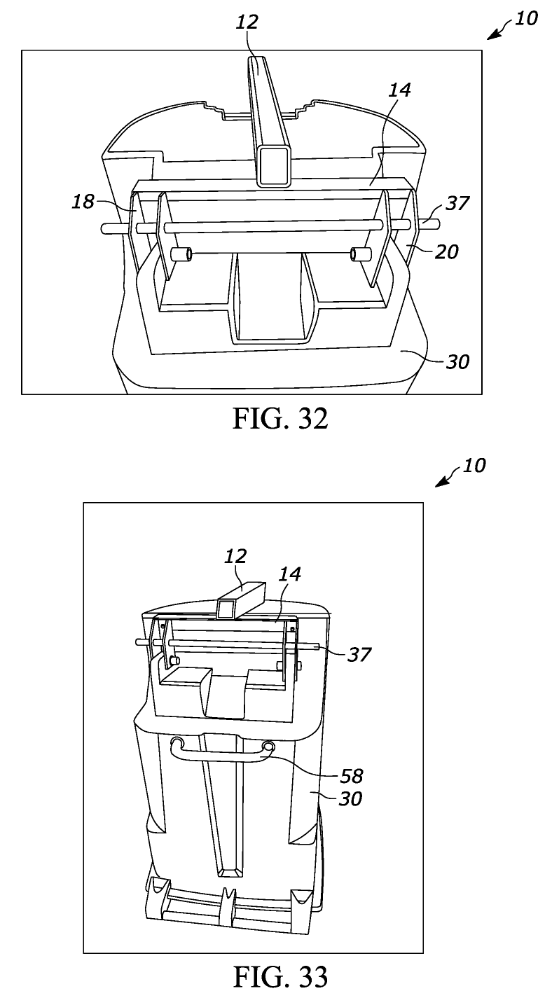

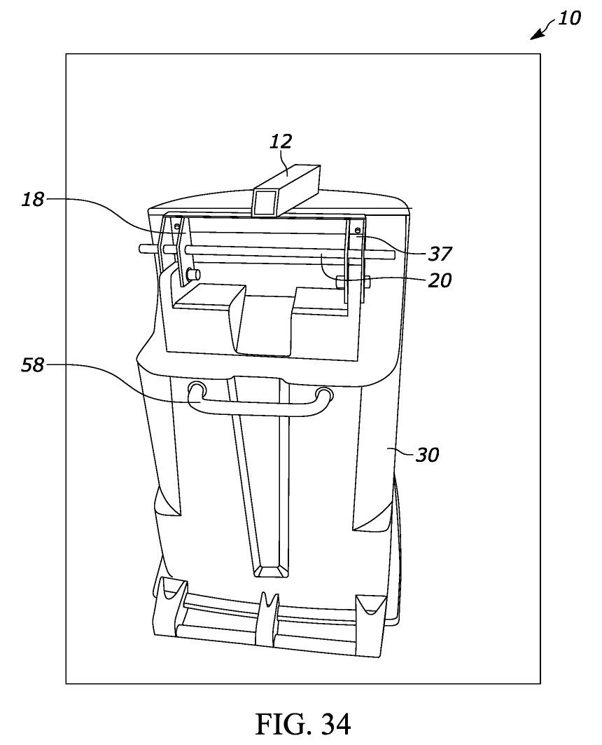

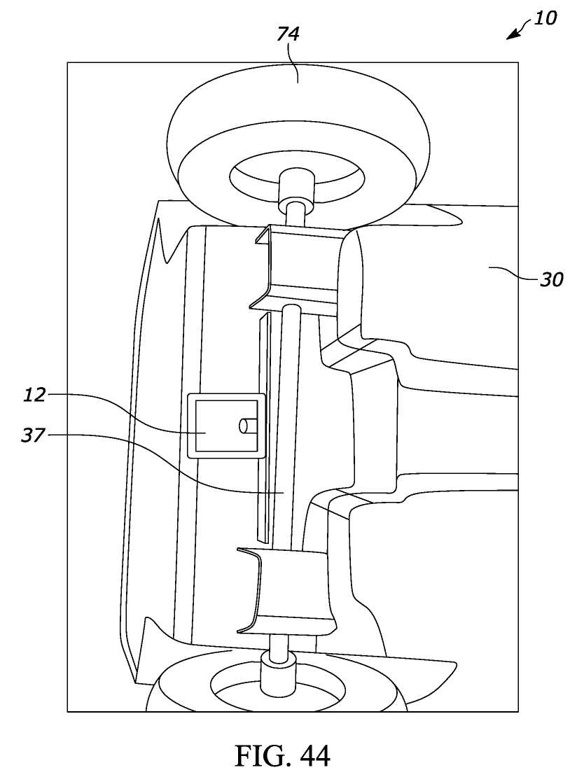

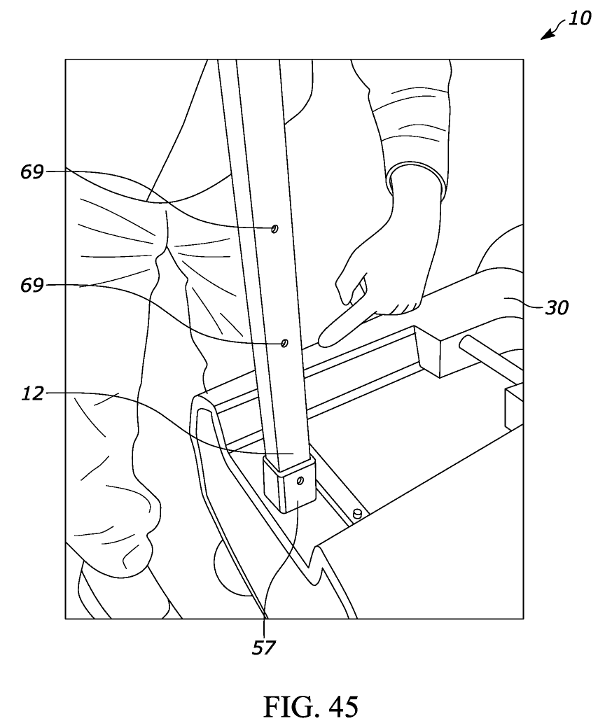

As shown in FIG. 29-34, when in an assembled position with a container 30, the elongated support member 12 is cantilevered and extends past the rear stabilizer 14 of the container 30 and includes a vehicle coupling inlet 62 which extends axially through a three-dimensional geometric configuration of the elongated support member 12. In FIGS. 35-39, the vehicle coupling inlet 62 is mounted to a vehicle channel mount or receiver 64 located along the underside of a vehicle. The chamfered sidewall 12c of the elongated support member 12 advantageously allows the vehicle mounting assembly 10 to move between a first locked position 66 and a second extended position 68, as shown by FIGS. 36 and 37, respectively. Advantageously, the elongated support member 12 coupling to the vehicle channel mount 64 allows for the container 30 to maintain clearance from a vehicle to avoid any collisions between the container when it is supporting a heavy load and the vehicle. In another example embodiment of the present disclosure, as shown in FIGS. 44-47, the two-piece elongated support member 12 shown comprises several additional inlets 69 such that the position between the elongated support member 12 and a coupled vehicle can advantageously be adjusted between a plurality of positions.

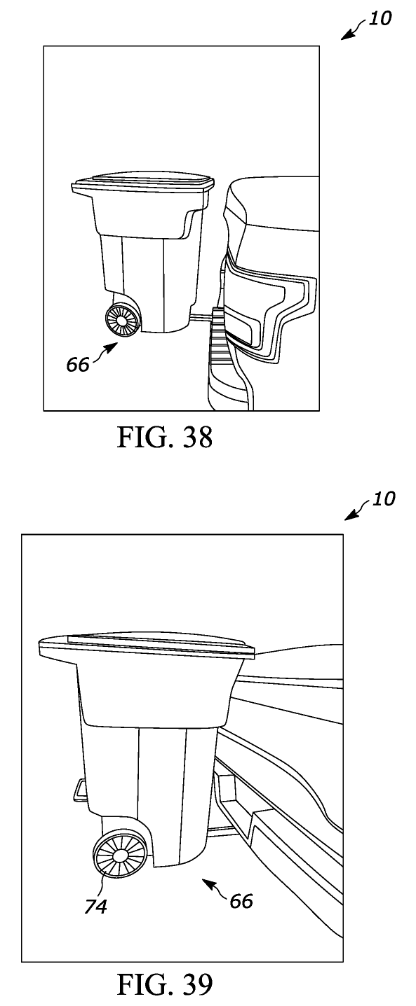

The vehicle channel mount 64 houses and secures the elongated bracket 12 in a nested arrangement such that the load of the container 30 is stabilized. The elongated support member 12 slidably engages with the vehicle channel mount 64, allowing for smooth translational movement of the system 10 between the first 66 and second 68 positions. FIGS. 38 and 39 show further views of the first locked position 66. The receiver stop 50 located approximately 3-4 inches within the channel 13 of the elongated bracket 12 allows for the elongated bracket to be secured to the vehicle channel mount 64 in the locked position. In another example embodiment, as shown in FIGS. 44-47, the elongated bracket 12 can move between several positions to adjust the distance between the load-bearing container 30 and a coupled vehicle. In this example embodiment, a locking pin assembly 72 further secures the elongated support member 12 to the vehicle channel mount 64.

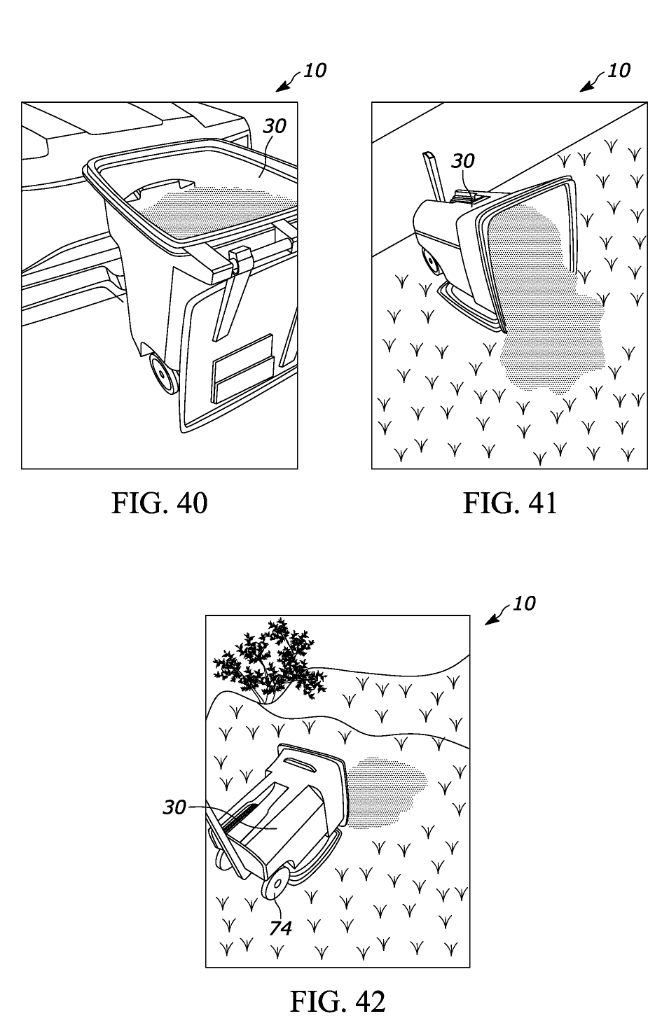

FIG. 40 shows the container 30 of the vehicle mounting assembly 10 carrying an example waste load of grass clippings, then being uncoupled from a vehicle in FIGS. 41-42 when the load is removed. In one example embodiment of the present disclosure, the container 30 used in connection with the system 10 can bear a load of 320-350 pounds. In FIGS. 41 and 42, the elongated support member 12 has been disconnected and removed from the vehicle channel mount 64 so that the waste may be disposed. One of ordinary skill in the art, after having the benefit of reviewing the specification and drawings of the present disclosure, would understand that containers that bear a variety of loads are contemplated within the spirit and scope of the present disclosure.

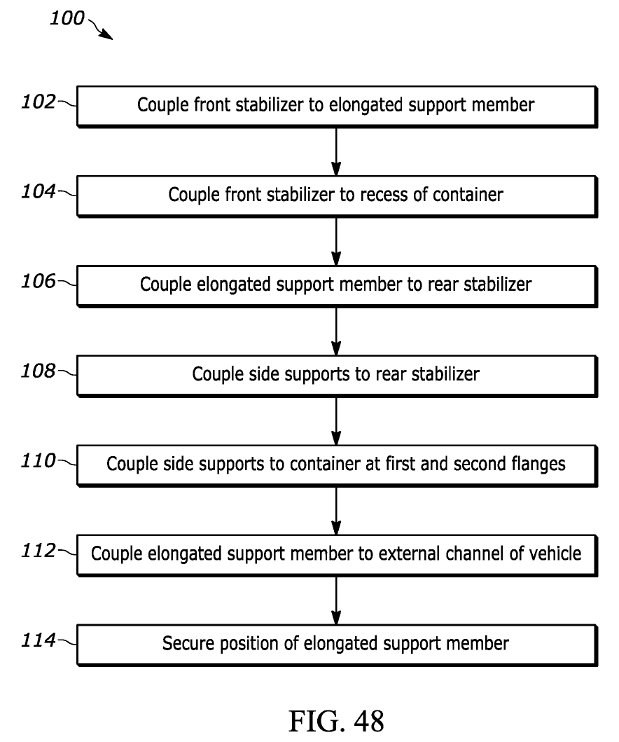

A method of use 100 for the vehicle mounting system 10 as shown in FIG. 48 will now be described. At method step 102, a front stabilizer 16 is coupled to an elongated support member 12. At step 104, a container 30 having a recess 30a and first and second inlets is coupled to the assembled front stabilizer 16 and elongated support member 12. At step 106, the elongated support member 12 is coupled to a rear stabilizer 14. At step 108, side supports 18, 20 holding an axle rod 37 are coupled to the rear stabilizer 14. At step 110, side supports 18, 20 are coupled to the container 30 at first and second flanges. At step 112, elongated support member 12 is coupled to an external channel 70 of a vehicle. Finally, at step 114, the elongated support member is locked into a first 66 or second 68 position, depending on the desired distance between the system 10 and vehicle.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%.

The term “coupled” as used herein is defined as connected or in contact either temporarily or permanently, although not necessarily directly and not necessarily mechanically. A device or structure that is “configured” in a certain way is configured in at least that way but may also be configured in ways that are not listed. The term “integral” as used herein unless defined otherwise means configured in such a way that separation would require destruction to the parts or the assembly of the parts.

It should be appreciated by those of ordinary skill in the art after having the opportunity of reviewing the drawings and/or specification of the present disclosure that it may include one or more embodiments, e.g., E₁, E₂, …Eₙ and that each embodiment E may have multiple parts A₁, B₁, C₁….Zₙ that (without further description) could be combined with other embodiments Eₙ, embodiment parts e.g. A₁, C₁, or lack of parts originally associated with one or all embodiments Eₙ, or any combination of parts and/or embodiments thereof. It should further be appreciated that an embodiment Eₙ may include only one part e.g. A₁ or a lesser number of parts e.g. B₁, C₁ of any embodiment or combination of embodiments that was described or shown in the specification and/or drawings, respectively in ways not enumerated or illustrated.

To the extent that the materials for any of the foregoing embodiments or components thereof are not specified, it is to be appreciated that suitable materials would be known by one of ordinary skill in the art for the intended purposes after having the benefit of reviewing the subject disclosure and accompanying drawings.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A vehicle-mounting container system adapted and configured to be removably couplable to a vehicle receiver comprising:
an elongated support member having first and second ends forming a hollow channel;
a front stabilizing bracket defining a first planar surface and a second planar surface formed at an angle to said first planar surface, said first planar surface coupled to said elongated support member between said first and second ends of said elongated support member;
a container having a continuous sidewall extending from a base portion, said continuous sidewall and said base portion together forming a hollow cavity, said base portion including first and second flanges, said base portion being removably attached to said front stabilizing bracket;
a rear stabilizing bracket having first and second ends, said rear stabilizing bracket coupled to said elongated support member at said elongated support member first end; and
first and second side support members forming a nested arrangement with said first and second flanges of said container, said first and second side support members being coupled to said first end and said second end of said rear stabilizing bracket, respectively, said first and second side support members supporting first and second ends of an axle rod extending therethrough.

2. The vehicle-mounting container system of claim 1, wherein said container further comprises a recessed portion opposite said first and second flanges of said base portion.

3. The vehicle-mounting container system of claim 2, wherein said first planar surface of said front stabilizing bracket forms a nesting arrangement with said recessed portion of said container.

4. The vehicle-mounting container system of claim 1 wherein said elongated support member terminates with a chamfered edge.

5. The vehicle-mounting container system for a load-bearing container of claim 1 wherein said elongated support member further comprises a receiver stop.

6. The vehicle-mounted container system for a load-bearing container of claim 1 wherein said rear stabilizing bracket comprises a first planar surface formed at an angle to a second planar surface.

7. The vehicle-mounting container system for a load-bearing container of claim 6 wherein said first planar surface of said rear stabilizing bracket supports and is removably couplable to said second end of said elongated support member.

8. The vehicle-mounting container system of claim 6 wherein said second planar surface is removably attached to said first and second side supports.

9. The vehicle-mounting container system of claim 1 wherein said first and second ends of said axle rod are removably attached to first and second wheels.

10. A vehicle-mounting apparatus adapted and configured to removably couple a load-bearing container to a vehicle receiver comprising:
an elongated support member having first and second ends forming a hollow channel;
a front stabilizing bracket defining a first planar surface and a second planar surface formed at an angle to said first planar surface, said first planar surface coupled to said elongated support member between said first and second ends of said elongated support member;
a rear stabilizing bracket having first and second ends, said rear stabilizing bracket coupled to said elongated support member at said elongated support member first end; and
first and second side support members, said first and second side support members being coupled to said first end and said second end of said rear stabilizing bracket, respectively.

11. The vehicle mounting apparatus of claim 10 wherein said elongated support member further includes a receiver stop.

12. The vehicle mounting apparatus of claim 10 wherein said elongated support member is constructed from a rust-resistant material.

13. The vehicle mounting apparatus of claim 10 wherein said elongated support member terminates into first and second chamfered edges.

14. The vehicle mounting apparatus of claim 10 further comprising an axle rod extending through said first and second side support members.

15. The vehicle mounting apparatus of claim 10 wherein said elongated support member further comprises a vehicle coupling inlet at said first end which extends axially through said hollow channel of said elongated support member.

16. A method of using a vehicle mounting system for a load-bearing container adapted and configured to be removably couplable to a vehicle receiver comprising the steps of:
providing a container having a base portion and a continuous sidewall, the base portion and continuous sidewall together forming a hollow cavity, said base portion including a recessed portion opposite first and second flanges;
coupling a front stabilizer bracket to said recessed portion of said container;
coupling first and second side supports to said first and second flanges of said container, said first and second side supports forming a nesting arrangement with said first and second flanges;
coupling a rear stabilizer bracket to said first and second side supports; and
coupling an elongated support member having first and second ends forming a hollow channel therein to said front and rear stabilizer brackets, said first end of said elongated support member cantilevered from said base portion of said container.

17. The method of using a vehicle mounting system of claim 16 further comprising the steps of:
inserting an axle rod having first and second ends through said first and second side supports; and
coupling first and second wheels to said first and second ends of said axle rod.

18. The method of using a vehicle mounting system of claim 16 further comprising the step of coupling said first end of said elongated support member to a vehicle receiver.

19. The method of using a vehicle mounting system of claim 16 further comprising the step of securing said elongated support member into a locked position in said vehicle receiver.

20. The method of using a vehicle mounting system of claim 16 further comprising the step of securing said elongated support member into an extended position in said vehicle receiver.
